(19) United States
(12) Patent Application Publication
(10) Pub. No.: US 2009/0080688 A1
(43) Pub. Date: Mar. 26, 2009

(54) DIGITAL WATERMARKING FOR FEW-COLOR IMAGES

(75) Inventors: Oscar Chi Lim Au, Hong Kong (CN); Shu Kei Yip, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/860,730

(22) Filed: Sep. 25, 2007

(51) Int. Cl. G06K 9/00

(52) U.S. Cl. 382/100

(57) ABSTRACT

Systems and methodologies for embedding a watermark in a few-color image are provided herein. A digital watermarking algorithm named Spatial Unified Key Insertion (SUKI) can be utilized, wherein adaptive threshold halftoning can be performed in combination with contour shaping and modification to embed a binary logo into a digital image. Watermarking can be performed for an image using SUKI without introducing “salt-and-pepper” artifacts into the image. Further, watermarking techniques described herein can embed data into an image with a considerably high payload while providing excellent resistance against JPEG compression and other attacks and introducing no additional colors into an image.

### COPYRIGHT NOTICE AND PERMISSION

A portion of the disclosure of this patent document, namely one or more images, may contain material that is subject to copyright protection. Given the non-commercial nature of this patent document and mere use of the images to illustrate subject matter of the present application, facsimile reproduction by anyone of the patent document or the patent disclosure as it appears in the Patent and Trademark Office patent files or records is permissible, but the copyright owner otherwise reserves all copyright rights whatsoever. In this regard, the following notice shall apply to the images of FIGS. 9, 10A, 10B, and 12 of this document: Copyright® 2007, Microsoft Corp.

### TECHNICAL FIELD

The present disclosure relates generally to image processing, and more particularly to techniques for embedding a watermark into a few-color image.

### BACKGROUND

Digital watermarking techniques are often used to prove ownership and authenticity of media objects such as images. In many conventional watermarking algorithms, random sequences are used as watermarks for embedding in media objects. Recently, however, there has been a growing demand for techniques for embedding and watermarking real images, such as logos, into media objects in order to better declare their ownership. By embedding a logo into an image to create a watermarked image, the logo can be made readable by human eyes even when the watermarked image is corrupted. In order to make a watermark detectable in an image after “attacks” on the quality of the image, such as JPEG compression, the watermark should be perceptually transparent and robust. In other words, the difference between a watermarked image and a corresponding original image should not be observable, and an embedded watermark should be difficult to remove by applying common signal processing operations.

Most conventional watermarking algorithms primarily focus on natural images. In contrast, few algorithms exist for watermarking few-color images, such as cartoon images, because data hiding and watermarking for such images is more challenging than that for natural images. The main difference between few-color images and natural images is that few-color images generally do not contain complicated textures or color variations. Although watermarking algorithms for halftone images exist, these algorithms typically do not work for images with more than 2 colors. In one conventional algorithm for data hiding in few-color images, information is embedded by using “subblock and supblock” and pattern matching. However, this algorithm can cause “salt-and-pepper” artifacts to appear in watermarked images due to improper selection of pattern sets. Moreover, this algorithm cannot withstand attacks, such as JPEG compression, on the quality of a watermarked image. Accordingly, there exists a need for effective techniques for embedding a watermark in a few-color image that are resistant to changes of the quality of the watermarked image.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides systems and methodologies for embedding watermarks in few-color images. In particular, a digital watermarking algorithm named Spatial Unified Key Insertion (SUKI) can be utilized, wherein adaptive threshold halftoning can be performed in combination with contour shaping and modification to embed a binary logo into a digital image. In accordance with one aspect, SUKI can utilize a relationship between a halftone image formed by adaptive threshold halftoning and an original image to perform operations such as boundary block detection and contour shaping with a high degree of accuracy. As a result, watermarking can be performed for an image without introducing “salt-and-pepper” artifacts into the image. In accordance with another aspect, watermarking techniques described herein can embed data into an image with a considerably high payload and provide excellent resistance against JPEG compression and other attacks. Further, watermarking techniques described herein can operate without introducing any additional colors into an image or changing a color palette of an image.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

FIG. 1 is a high-level block diagram of a system for processing and communicating an image in accordance with various aspects set forth herein.

FIG. 2 is a block diagram of a system for watermarking an image in accordance with various aspects.

FIGS. 3-4 illustrate example color histograms that can be obtained from an image for adaptive threshold halftoning in accordance with various aspects.

FIG. 5 is a block diagram of a system for identifying candidate blocks for embedding watermark data in an image in accordance with various aspects.

FIG. 6 illustrates example boundary block structures in accordance with various aspects.

FIG. 7 is a block diagram of a system for performing contour shaping for an image in accordance with various aspects.

FIG. 8 illustrates example contour shaping operations in accordance with various aspects.

FIG. 9 illustrates example few-color images and an example watermark that can be utilized in accordance with various aspects.

FIGS. 10A-B illustrate an example original image and watermarked image in accordance with various aspects.

FIG. 11 illustrates image quality data for an exemplary watermarking system in accordance with various aspects.

FIG. 12 illustrates examples of watermarked images obtained utilizing conventional watermarking techniques.

FIG. 13 illustrates a comparison between image quality data for an exemplary watermarking algorithm in accordance with various aspects and image quality data for conventional watermarking algorithms.

FIG. 14 is a flowchart of a method of watermarking and processing a few-color image.

FIG. 15 is a flowchart of a method of embedding a logo in an image based on a Spatial Unified Key Insertion algorithm.

FIG. 16 is a block diagram of an example operating environment in which various aspects described herein can function.

FIG. 17 is a block diagram of an example networked computing environment in which various aspects described herein can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

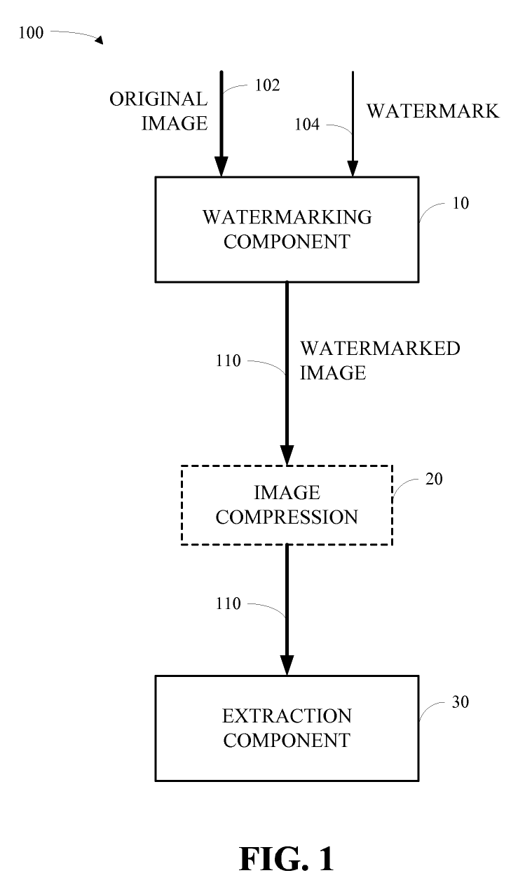

Referring to the drawings, FIG. 1 illustrates a high-level block diagram of a system 100 for processing and communicating an image in accordance with various aspects described herein. In one example, system 100 includes a watermarking component 10 that can create a watermarked image 110 from an original image 102 by embedding a watermark 104 in the original image 102. While watermark 104 is illustrated in system 100 as provided to the watermarking component 10 from an external source, it should be appreciated that a watermark 104 used by the watermarking component 10 can alternatively be generated by the watermarking component 10.

Additionally and/or alternatively, the watermarking component 10 can receive a video sequence containing a series of video frames. The watermarking component 10 can process some or all of the frames in the video sequence as a series of original images 102, into which the watermarking component 10 can embed one or more watermarks 104 to generate corresponding watermarked images 110. The watermarking component 10 and/or another suitable entity can then replace original frames in the video sequence with their respective watermarked frames to facilitate transmission of a watermarked video sequence to other entities in system 100.

In accordance with one aspect, the watermarking component 10 can be utilized to embed a binary watermark 104 into few-color original images 102. As used herein, the term “few-color image” refers to an image that is composed of large, monochromatic regions separated by well-defined edges of a uniform color, such as black. For example, many cartoon pictures and other suitable images that exhibit the above features can be regarded as few-color images. In addition, while few-color images generally utilize a palette of 2-20 colors, algorithms that can be performed by the watermarking component 10 and techniques described herein can be applied to images that utilize a larger color palette and/or images that do not exhibit all of the above features.

Because few-color images often include large, uniform image regions, conventional watermarking algorithms typically cannot be utilized for such images without distorting the image or modifying the color palette of the image. To overcome these difficulties, watermarking component 10 can utilize a Spatial Unified Key Insertion (SUKI) algorithm to embed a binary watermark 104 into a few-color original image 102 with minimal perceivable distortion and without modifying the color palette of the original image 102. In one example, SUKI can be utilized by watermarking component 10 to locate and modify selected pixels of an original image 102 at boundary areas between an image region and an edge based on data provided by a binary watermark 104. In another example, only colors that are present in the original image 102 are utilized for modifying pixels, thereby preserving the color palette of the original image 102.

In accordance with another aspect, SUKI and/or other algorithms utilized by the watermarking component 10 can take properties of human perception into account to provide effective and visually pleasing watermarked images 110. By way of specific example, straight edges in an image are generally perceived with more sensitivity to changes than curved edges. Accordingly, to facilitate perceptually transparent watermarking of images, the watermarking component 10 can select areas of an original image 102 that are less sensitive to variation and utilize only those areas for embedding a watermark 104.

In accordance with a further aspect, watermarked images 110 generated by the watermarking component 10 are then communicated through one or more communication channels to an extraction component 30, which can extract watermarks 104 from respective watermarked images 110. In one example, the extraction component 30 can obtain a binary watermark 104 that has been embedded in a received image 110 by employing a watermarking algorithm such as SUKI to determine which pixels in the received image provide data relating to the watermark. The determined pixels and/or their surrounding areas can then be examined to ascertain data comprising the watermark 104. In one example, the size and shape of a watermark 104 utilized by watermarking component 10 can be communicated from the watermarking component 10 to the extraction component 30 or known a priori by the extraction component 30.

In one example, watermarked images 110 communicated by the watermarking component 10 can additionally be modified by an image compression operation 20 and/or one or more other image quality attacks present in the communication channel between the watermarking component 10 and the extraction component 30. Image compression 20 present in the communication channel between the watermarking component 10 and the extraction component 30 can include one or more image compression techniques that can be used to compress a watermarked image 110 prior to extraction by the extraction component 30. Image compression techniques that can be utilized include JPEG compression and/or any other suitable image compression technique. In accordance with one aspect, watermarked images 110 generated by the watermarking component 10 using SUKI and/or another appropriate watermarking algorithm can be made resistant to image compression 20 performed in the communication channel between the watermarking component 10 and the extraction component 30. Accordingly, a watermark 104 embedded in a watermarked image 110 can be preserved through communication from the watermarking component 10 to the extraction component 30 with little or no deviation.

To facilitate the communication of watermarked images 110 between entities in system 100, one or more wired (e.g., Ethernet, IEEE-802.3, etc.) and/or wireless (IEEE-802.11, Bluetooth™, etc.) networking technologies can be utilized. Additionally, extraction component 30 can be directly connected to watermarking component 10 or indirectly connected through a third party device (not shown). For example, extraction component 30 can be associated with a client computer that receives images 110 and/or 120 from a Web server that provides media content over the Internet via an Internet service provider (ISP). As another example, extraction component 30 can be associated with a mobile terminal that accesses media content via a cellular communications network such as the Global System for Mobile Communications (GSM), a Code Division Multiple Access (CDMA) communication system, and/or another suitable cellular communications network.

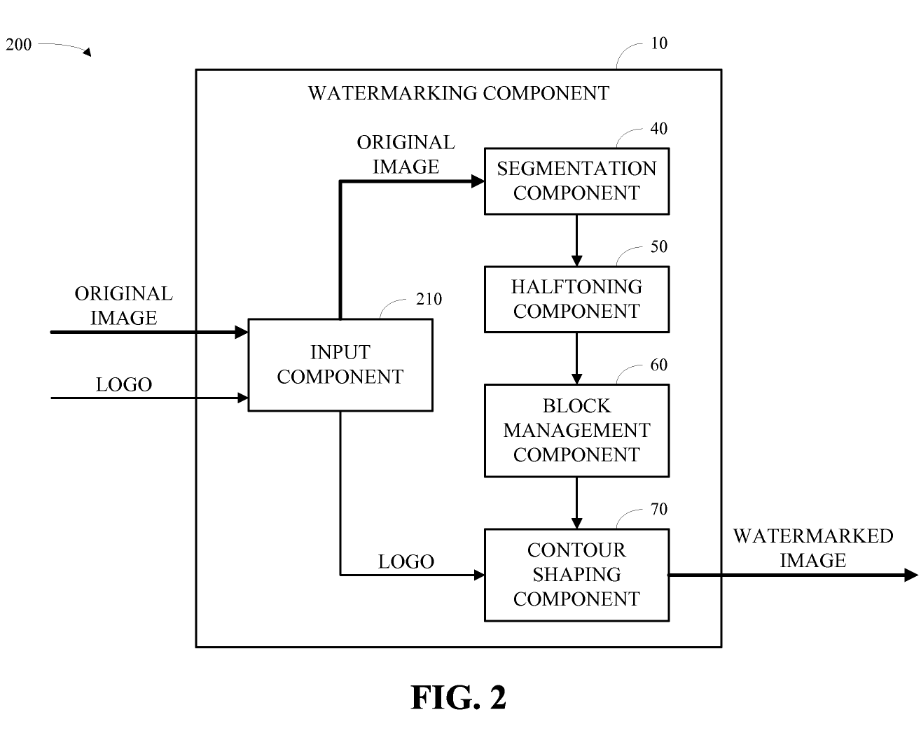

Referring now to FIG. 2, a block diagram of a system 200 for watermarking an image in accordance with various aspects is illustrated. In one example, system 200 includes a watermarking component 10 that can utilize one or more watermarking algorithms to embed a watermark in an original image to obtain a watermarked image. The watermark component can include an input component 210 that can receive an original image to be watermarked and/or a logo to embed in the original image. In accordance with one aspect, watermarking component 10 can utilize SUKI and/or other algorithms for embedding a watermark in a few-color image. As described above, few-color images are images having limited color palettes, usually between 2 and 20 colors, which exhibit the following three properties. First, few-color images are composed of large, homochromatic regions. Second, distinct boundaries are present in few-color images between their homochromatic regions. Third, a common color (e.g., black) is used for all edges in few-color images. In one example, an original image provided to watermarking component 10 can be a few-color image that exhibits the above properties, into which the watermarking component 10 can embed a logo in the spatial domain using SUKI and/or one or more watermarking algorithms designed for few-color images. Alternatively, an original image can be provided to a segmentation component 40, which can segment the original image into multiple objects that respectively exhibit the above three properties of few-color images.

In accordance with another aspect, the watermarking component 10 can further include a halftoning component 50, a block management component 60, and a contour shaping component 70 that can utilize SUKI to embed a binary logo L into an original image S of size S_{X}×S_{Y}, or a series of image objects generated from original image S by the segmentation component 40, in order to form a watermarked image W. In one example, the halftoning component 50 can utilize adaptive threshold halftoning and/or another suitable halftoning method to approximate a binary image from the original image S and/or its segmented image objects. As will be described in more detail infra, by utilizing halftoning, watermarked images W created by watermarking component 10 can be given superior resistance to JPEG compression and other image attacks. After the halftoning component 50 creates a binary halftoned image corresponding to an original image S, the block management component 60 can select boundary blocks and candidate blocks in the halftoned image for embedding the binary logo L. In accordance with one aspect, because halftoned images produced by the halftoning component 50 only consist of binary color, the boundary block detection performed by the block management component 60 can be carried out with a high degree of accuracy. In one example, after selecting boundary blocks, the block management component 60 can select some of the boundary blocks as possible candidate blocks for embedding under certain requirements. This selection process can be performed, for example, to ensure perceptual transparency of a logo L in a final watermarked image W. Once candidate blocks are selected by the block management component 60, these blocks can then be communicated to a contour shaping component 70 that can perform contour shaping and watermarking based on the binary logo L. In one example, the contour shaping component 70 can embed one information bit corresponding to logo L in each candidate block provided by the block management component 60. The operation of each of blocks 50-70 is described in more detail infra.

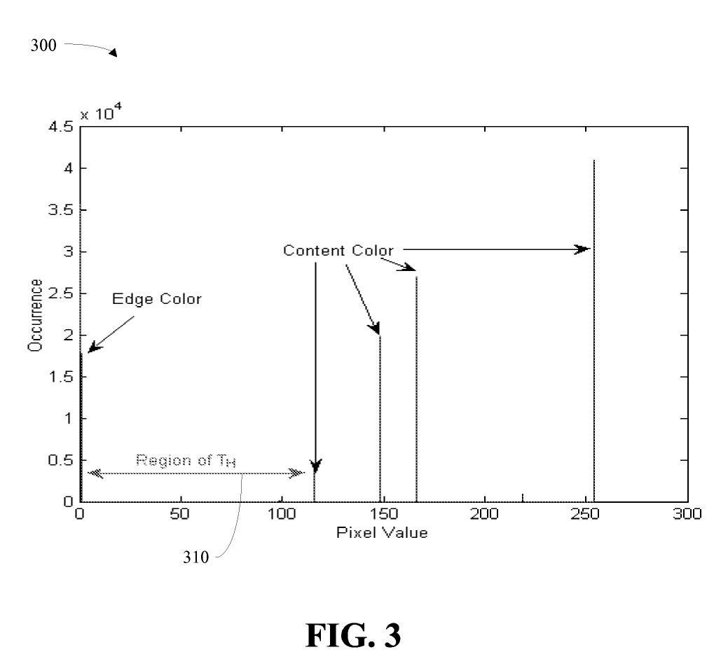

Turning to FIG. 3, an example color histogram 300 that can be obtained from an image for adaptive threshold halftoning in accordance with various aspects is illustrated. In one example, color histogram 300 can be utilized by halftoning component 50 to create a binary halftoned image from an original few-color image or few-color image objects obtained from segmentation component 40. In accordance with one aspect, halftoning component 50 can perform halftoning on an image by first defining a threshold for halftoning, T_{H}. The threshold T_{H} can be determined, for example, by examining image colors and an edge color present in histogram 300. In one example, the edge color of a few-color image can be detected using simple edge detection techniques. In one example, the halftoning component 50 can assume that the edges of an image are black in color. In another example, an image having edges of multiple colors can be halftoned by halftoning component by first utilizing segmentation component 40 to divide the image into segments of uniform edge color.

Histogram 300 illustrates example color frequency data obtained from a test image. As can be observed from histogram 300, four peaks for pixel values corresponding to content colors and one peak for a pixel value corresponding to an edge color is illustrated. Thus, the color palette of the test image corresponding to histogram 300 contains five colors in total with four colors used for image regions and one color used for edges. In accordance with one aspect, halftoning can be performed for an image corresponding to histogram 300 by first detecting a peak for each content color. Peaks in histogram 300 can be detected using any suitable method. By way of example, a pixel value in histogram 300 can be regarded as a peak when the occurrence of the pixel value is greater than 0.1 percent of the total samples in the image. Thus, the threshold for detecting a peak, Tₚ, can be expressed as follows:

Tₚ=0.001×Sₓ×S_{y} (1)

Once peak detection has been performed for histogram 300, the peak pixel value corresponding to the edge color can be denoted as P_{E} and the minimum peak pixel value corresponding to the content colors can be denoted as P_{M}. In accordance with one aspect, a halftoning threshold T_{H} for use by halftoning component 50 can then be determined using these peak values as follows. First, T_{H} can be defined as one of the values in the region between P_{E} and P_{M}, such that T_{H}ε{P_{E}, . . . , P_{M}}. The region of possible values for the threshold T_{H} is illustrated in histogram 300 as region 310. In one example, once region 310 for T_{H} is determined, T_{H} can then be selected from the region 310 based on the following procedure. First, if there are pixel values in region 310 of histogram 300 having zero occurrences, the pixel values with zero occurrences can be added to a “Zero Occurrence Set,” ZSet. T_{H} can then be set to the median of ZSet. Second, if ZSet is empty, T_{H} can instead be set to a weighted average of P_{E} and P_{M}. If, for example, the weighting of P_{E} and P_{M} are set to be equal, T_{H} can be set to the average of P_{E} and P_{M}.

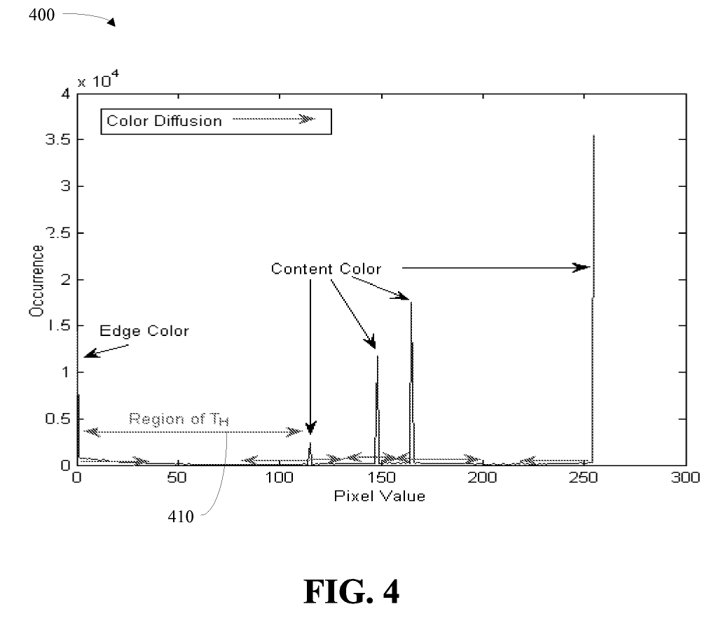

FIG. 4 illustrates an additional example color histogram 400 that can be utilized by the halftoning component 50 for adaptive threshold halftoning in accordance with various aspects. In accordance with one aspect, T_{H} is not a predefined threshold but is instead adaptively chosen based on histograms 300 and/or 400. When no attack, such as JPEG compression, has been performed on an image, all pixel values between P_{E} and P_{M} usually belong to ZSet, as illustrated by histogram 300. However, when JPEG compression or other degradation is performed on an image, the number of pixel values belonging to ZSet can reduce, as illustrated by histogram 400. This is due to, for example, the “color diffusion” aspect of JPEG compression.

It can be observed from histogram 400 that, as compared to histogram 300, the sharp peaks present in histogram 400 become triangular in shape. This difference between histogram 300 and histogram 400 is a result of color diffusion, which is in turn caused by quantization and finite-precision operations performed during the discrete cosine transform (DCT) stage of JPEG compression. It can be observed that images having larger differences between P_{E} and P_{M} are more adaptive to color diffusion than images with smaller differences between P_{E} and P_{M}. As a result, it follows that images having larger differences between P_{E} and P_{M} are more likely to have a non-empty ZSet. In accordance with one aspect, halftoning component 50 can reduce or eliminate the effect of color diffusion on an image by selecting a suitable T_{H}, especially when ZSet is a non-empty set. After a value for T_{H} is selected, halftoning component 50 can then perform adaptive threshold halftoning to create a halftoned image S_{H} from an original image S as follows:

$${S}_{H} ( x , y ) = \{ \begin{matrix}1 & if S ( x , y ) \geq {T}_{H} \\ 0 & if S ( x , y ) < {T}_{H} .\end{matrix} \qquad ( 2 )$$

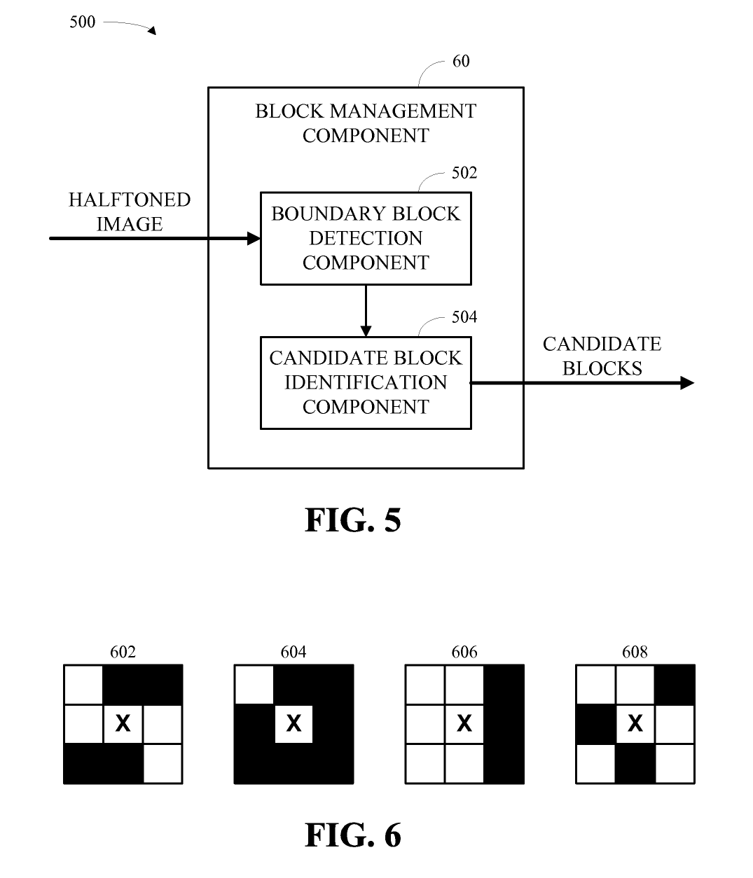

Referring now to FIG. 5, a system 500 for identifying candidate blocks for embedding watermark data in an image in accordance with various aspects is illustrated. System 500 includes a block management component 60, which can include a boundary block detection component 502 for determining boundary blocks present in a halftoned image (e.g., a halftoned image produced by a halftoning component 50) and a candidate block identification component 504 for identifying boundary blocks determined by the boundary block detection component 502 that are candidates for embedding watermark data.

In accordance with one aspect, a halftoned image S_{H} provided to block management component 60 can be a binary image such that S_{H} (x,y)ε{0, 1} for all pixels in S_{H}. As used in the following description and drawings, black pixels are utilized to represent pixels in S_{H} having a value of 0 and white pixels are utilized to represent pixels in S_{H} having a value of 1. It should be appreciated, however, that this is only one manner in which the binary halftoned image S_{H} can be expressed and that other manners of representing S_{H} are possible. The boundary block detection component 502 can divide a halftoned image S_{H} into N×N blocks, where N is an odd number greater than 1. The boundary block detection component 502 can then detect which blocks created from S_{H} are boundary blocks by finding blocks having a total intensity not equal to zero or N². In one example, upon detecting the boundary blocks in S_{H}, the boundary block detection component 502 can assign the boundary blocks to a “boundary block set,” which can be denoted as BSet.

In another example, after the boundary block detection component 502 identifies BSet, the candidate block identification component 504 can look for blocks in BSet that are suitable for embedding data. In accordance with one aspect, the candidate block identification component 504 can identify candidate blocks in BSet for embedding data by investigating the pixels in each block of S_{H} except for the center pixel of each block. Based on this determination, the candidate block identification component 504 can identify blocks that meet the following three requirements. First, the number of black pixels in a block should be approximately the same as the number of white pixels in the block, which can be expressed as the following inequality:

ceiling(N/2)×N−1≧Int_{B|C}≧N, (3)

where Int_{B|C} represents the total intensity of a block without the center pixel. Second, all black pixels in a block should be connected together. This requirement ensures that there are only two clusters in each candidate block, which together with the first requirement reduces the appearance of “salt-and-pepper” artifacts after embedding. Third, where Int_{B|C}=N for a block, the black pixels in the block should not be in a horizontal or vertical line. Because the human visual system is more sensitive to strong vertical and horizontal edges, the third requirement is used to preserve blocks with strong vertical and/or horizontal edges in order to maintain high visual quality.

FIG. 6 illustrates example boundary block structures 602-608 that can be detected by boundary block detection component 502 and analyzed by candidate block identification component 504. In particular, boundary block structures 602-608 illustrate examples of boundary blocks of size N=3 that can belong to a boundary block set BSet but can be considered unsuitable for embedding by candidate block identification component 504. In particular, structure 602 can be considered unsuitable for embedding as it contains two groups of black pixels and therefore does not meet the second of the above requirements. Further, structure 604 does not meet the first above requirement as it contains significantly more black pixels than white pixels. Next, structure 606 does not meet the third of the above requirements because the black pixels in structure 606 form a vertical line. Finally, similar to structure 602, structure 608 does not meet the first above requirement because it does not contain only one group of black pixels. As used in structures 602-608, the “X” in the center of each structure 602-608 denotes that the center pixel is not considered for candidate block identification.

On the other hand, boundary blocks that do satisfy the above three requirements can be regarded by candidate block identification component 504 as candidates for embedding and placed in an “embedding block set,” which can be denoted as ESet. The blocks in ESet can then be provided to further watermarking components, which can embed one information bit in each block of ESet.

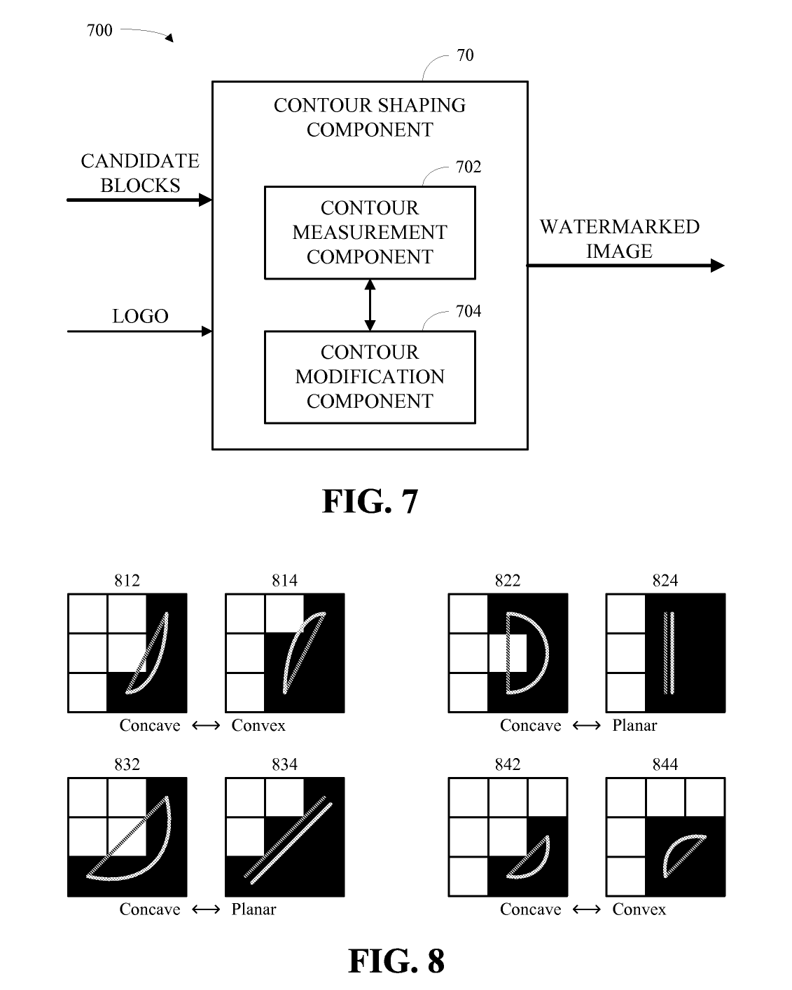

Referring to FIG. 7, a system 700 for performing contour shaping for an image in accordance with various aspects is illustrated. In one example, system 700 includes a contour shaping component 70, which can include a contour measurement component 702 and a contour modification component 704. The contour shaping component 70 can receive a set of candidate blocks (e.g., a set of candidate blocks generated by a block management component 60) corresponding to an image and a logo to be embedded in the image. Upon receiving a logo and a set of candidate blocks, the contour measurement component 702 and contour modification component 704 can collectively embed the logo into the candidate blocks to create a watermarked image.

In accordance with one aspect, contour shaping for a set of candidate blocks ESet can be performed by the contour shaping component 70 as follows. First, the contour measurement component 702 can divide the blocks in ESet into three groups according to their contours, which can be denoted as “Concave Blocks,” “Convex Blocks,” and “Planar Blocks.” In one example, the contour measurement component 702 can determine the contour of a block by using the two outermost black pixels with the largest distance in each block to form a principal axis. Then, for an N×N block, the contour measurement component 702 can determine the contour of the block by connecting the black pixels that form the principal axis of the block to create a chain of at least N black pixels. Based on these determinations, the contour management component 704 can then modify the contours of the blocks in ESet according to a provided binary logo L. By way of example, convex blocks and planar blocks can be used to represent an information bit of “1” while concave blocks can be used to represent an information bit of “0.”

FIG. 8 illustrates contour pairs 812-814, 822-824, 832-834, and 842-844 that can be formed by contour shaping component 70 based on a set of candidate blocks. As illustrated in FIG. 8, the darker line at each block 812-844 represents the principal axis of the block while the lighter line at each block 812-844 represents the shape of contour of the block. As can be observed from blocks 812-844, contour modification can be performed by toggling the center pixel value of a block between a content color, represented as white in FIG. 8, and an edge color, represented as black in FIG. 8. For example, respective center pixels in blocks 812-844 can be toggled to switch between a concave block 812 and a convex block 814, a concave block 822 and a planar block 824, a concave block 832 and a planar block 834, and/or a concave block 842 and a convex block 844. In accordance with one aspect, by identifying corresponding blocks in an image S, the center pixels of respective blocks can be changed to a content color or an edge color according to a logo L.

In accordance with another aspect, watermark extraction can be performed (e.g., by an extraction component 30) in a similar manner to watermark embedding. For example, a halftoning threshold T_{H} can be selected according to an image histogram in a similar manner to halftoning component 50, and block sets BSet and ESet can be identified and located in a similar manner to block management component 60. In one example, because the contour shaping component 70 toggles the center pixels of respective blocks and the conditions for candidate block identification performed by block management component 60 are not dependent on center pixels, an ESet determined during watermark extraction can be substantially identical to an ESet determined for watermark embedding. In accordance with one aspect, watermarking performed by the watermarking component 30 can be resistant to image attacks such that the respective ESets determined during watermark embedding and extraction for an image are similar despite operations such as JPEG compression being performed on the image between embedding and extraction. Contour measurement can then be performed to extract a watermark for an image by determining the principal axis of each candidate block and identifying whether the candidate blocks are concave, convex or planar.

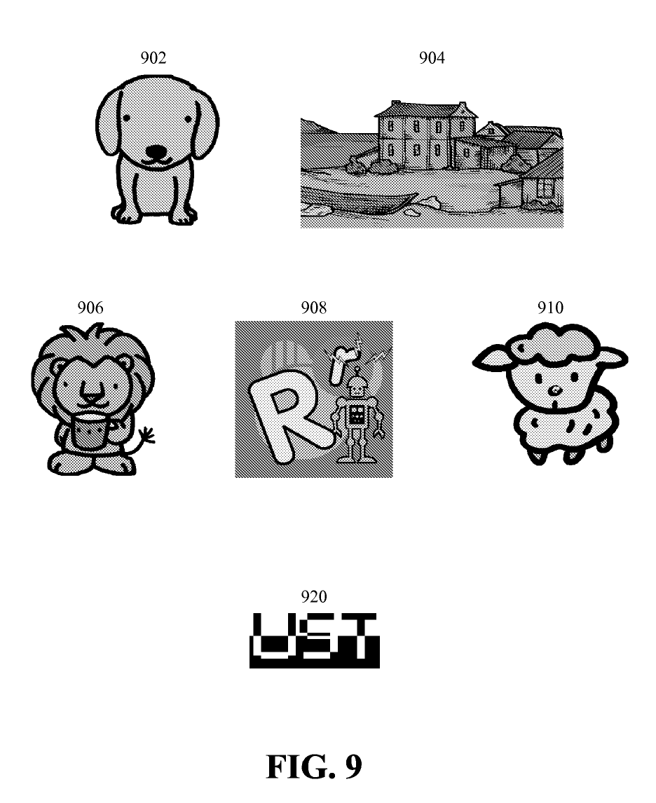

Turning to FIG. 9, an example binary watermark 920 and images 902-910 in which the watermark 920 can be embedded in accordance with various aspects set forth herein are illustrated. More particularly, images 902-910 are five few-color images obtained from Microsoft® Clip Art. As used herein, image 902 is referred to as Dog, image 904 is referred to as House, image 906 is referred to as Lion, image 908 is referred to as Robot, and image 910 is referred to as Sheep. Binary watermark 920 is designed to have an equal probability of “0” and “1” values.

During experimentation relative to the aspects described herein, watermark 920 was embedded into images 902-910 using SUKI in accordance with various aspects described herein. Only the luminance component of images 902-910 was used for watermarking. The performance of SUKI for the images 902-910 in terms of payload, peak signal-to-noise ratio (PSNR) and bit error rate (BER) is shown in Table 1 below:

TABLE 1
The Performance of Testing Images.

| Image | Size | Payload (bpp) | PSNR (dB) | BER |
|---|---|---|---|---|
| Dog | 320 × 420 | 0.00331 | 30.1488 | 0 |
| House | 560 × 400 | 0.00956 | 28.2542 | 0 |
| Lion | 320 × 400 | 0.00495 | 28.5179 | 0 |
| Robot | 400 × 400 | 0.00417 | 30.6055 | 0 |
| Sheep | 400 × 400 | 0.00265 | 30.2152 | 0 |

As illustrated in Table 1, payload is expressed as bits per pixel (bpp) and PSNR is expressed as dB. It can be observed from Table 1 that the average payload for images 902-910 is 0.004929 bpp, which is larger than that achievable through conventional watermarking approaches for few-color images. As further illustrated by Table 1, no bit error rate was experienced for any of images 902-910 as no attacks were introduced into images 902-910 during or after watermarking. As will be shown infra, however, the systems and methods described herein can withstand JPEG compression and other attacks to a great extent.

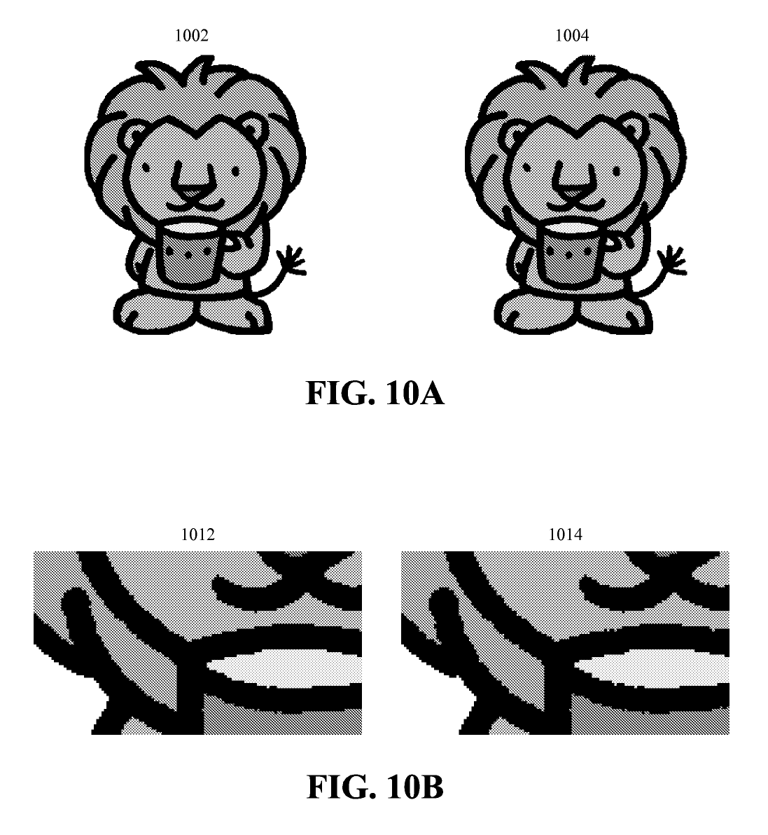

Referring now to FIGS. 10A-B, an example original image and watermarked image are illustrated. Specifically, FIGS. 10A-B illustrate Lion image 906 before and after watermarking using SUKI in accordance with various aspects described herein. Referring specifically to FIG. 10A, image 1002 illustrates Lion image 906 before watermarking and image 1004 illustrates Lion image 906 after watermarking. It can be observed that little to no visible distortion is present in watermarked image 1004, which demonstrates the perceptual transparency of the systems and methods described herein. FIG. 10B illustrates a detailed region 1012 of original image 1002 and a detailed region 1014 of watermarked image 1004. By comparing region 1012 to region 1014, changes in image pixels located near boundaries of edges and image regions can be observed. These changes represent toggling operations performed during watermarking (e.g., by a contour shaping component 70) on candidate blocks identified for embedding data.

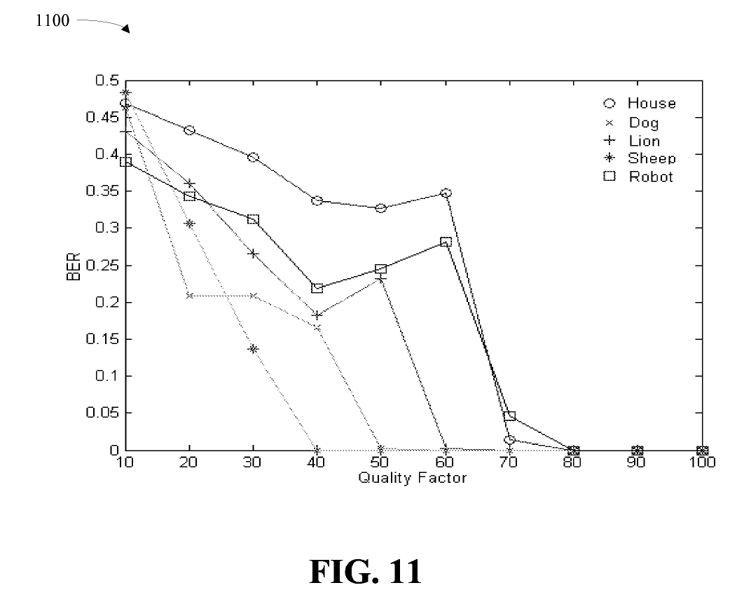

Turning now to FIG. 11, a graph 1100 is provided that illustrates image quality data for an exemplary watermarking system in accordance with various aspects. More specifically, graph 1100 illustrates the bit error rate (BER) observed for watermarks embedded in images 902-910 upon JPEG compression of varying quality factors (QFs). As can be seen from graph 1100, the BER for each test image is equal to zero for QF≧80. For QF=70, the BERs for three of the testing images are equal to zero; the BERs for the House image 904 and the Robot image 908 are 0.0144 and 0.0464, respectively. Further, for the Sheep test image 910, graph 1100 illustrates that BER is equal to zero for QF≧40. In accordance with one aspect, this superior JPEG resistance ability is provided, for example, by the adaptive threshold halftoning performed by halftoning component 50. In one example, the larger the difference between P_{E} and P_{M} for an image (e.g., as illustrated by histograms 300 and 400), the more resistive the image can be to JPEG compression. For the case of the Sheep test image 910, it accordingly follows that its low BER is due to the fact that its region between P_{E} and P_{M} is the largest among images 902-910.

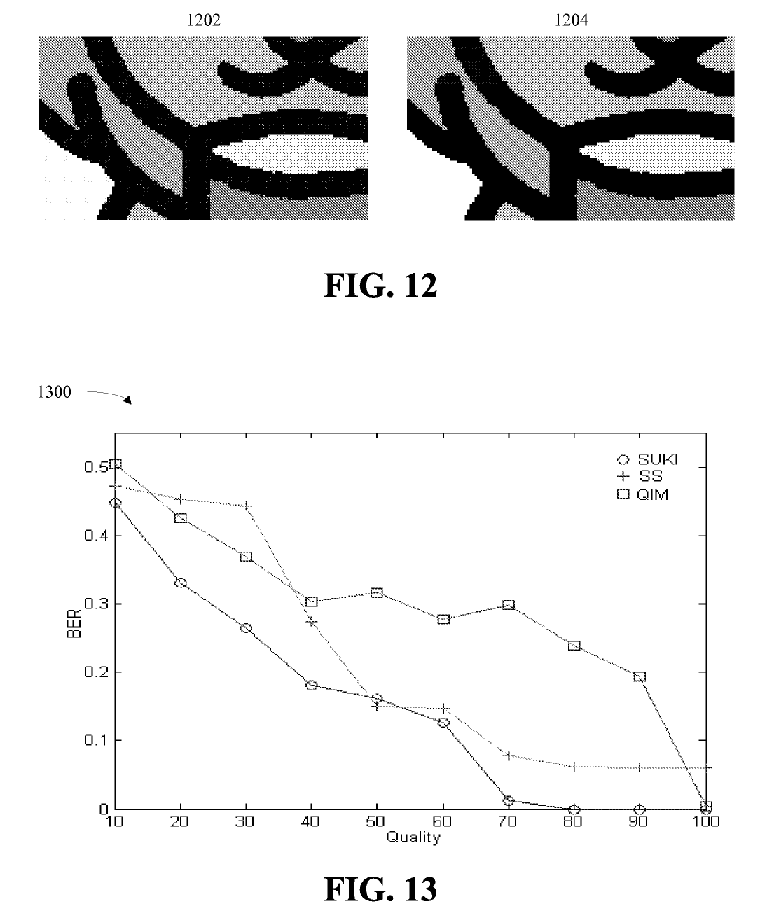

FIG. 12 illustrates examples of watermarked images 1202-1204 obtained utilizing conventional watermarking techniques. In particular, watermarked image 1202 was obtained using Spread Spectrum Watermarking (SS) and watermarked image 1204 was obtained using Quantization Index Modulation Watermarking (QIM). Both SS and QIM are typically used for watermarking of natural images. For image 1202 watermarked using SS, it is to be appreciated that the BER is nonzero even when no attack is present because the image and codewords use are not independent. This is demonstrated in FIG. 12 by the distortion present in image 1202. For image 1204 watermarked using QIM, it is to be appreciated that the image cannot withstand simple scaling operations as the centers of respective quantization cells utilized will be changed.

Referring now to FIG. 13, a graph 1300 is provided that illustrates a comparison between image quality data for an exemplary watermarking algorithm in accordance with various aspects and image quality data for conventional watermarking algorithms, namely SS and QIM. Graph 1300 illustrates average BER data for SUKI as described herein, SS, and QIM for similar payloads. For SS, the block size, the codeword size and α are set to 8, 16 and 12, respectively. Codewords are given a Walsh Code structure, and watermarking is performed as follows:

t′(x)=t(x)+α×c(x), (4)

where t′(x) are watermarked DCT coefficients, t(x) are original DCT coefficients, and c(x) is a codeword. For QIM, the quantization step size is set to 5. As shown in images 1202-1204 and graph 1300, although the visual quality of QIM illustrated by image 1204 is similar to SUKI, it is not resistant to JPEG compression, as illustrated by graph 1300. For SS, the visual quality of image 1202 is degraded as middle and/or high frequency components are introduced during watermarking. Further, as shown by graph 1300, the BER of SS is not as low as that of SUKI.

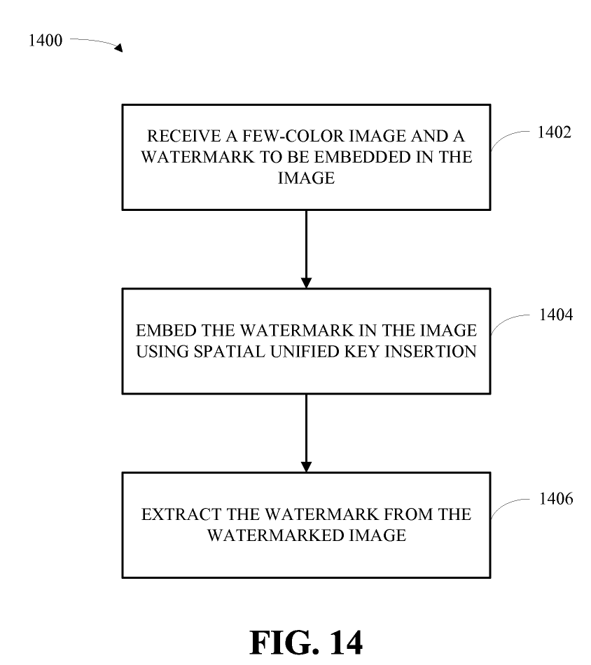

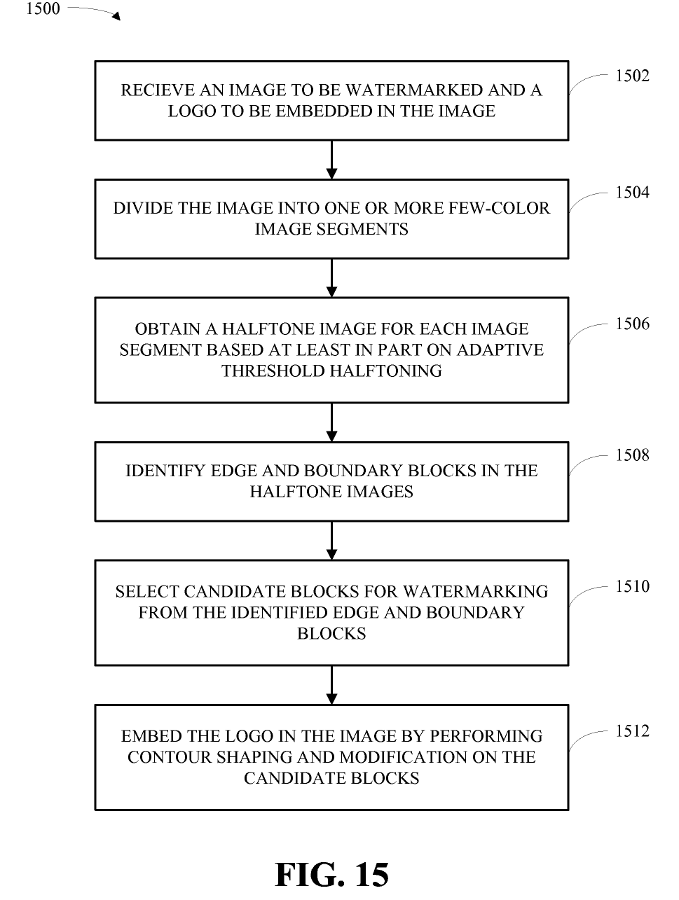

Referring now to FIGS. 14-15, methodologies that may be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 14, a method 1400 of watermarking and processing a few-color image is illustrated. At 1402, a few-color image (e.g., a few-color original image 102) and a watermark to be embedded in the image (e.g., a watermark 104) are received. At 1404, the watermark is embedded in the image (e.g., by a watermarking component 10) using Spatial Unified Key Insertion (SUKI). Finally, at 1406, the watermark is extracted (e.g., by an extraction component 30) from the watermarked image created at 1404 (e.g., a watermarked image 110). In one example, the watermarked image created at 1404 can be subject to one or more attacks (e.g., image compression 20) prior to extraction at 1406, and the watermarking performed at 1404 can provide resilience to the one or more attacks such that the watermark extracted at 1406 is substantially preserved between watermarking at 1404 and extraction at 1406.

Referring now to FIG. 15, a method 1500 of embedding a logo in an image based on a Spatial Unified Key Insertion algorithm is illustrated. At 1502, an image to be watermarked and a logo to be embedded in the image is received (e.g., by an input component 210). At 1504, the image is divided into one or more few-color image segments (e.g., by a segmentation component 40). At 1506, a halftone image is obtained (e.g., by a halftoning component 50) for each image segment created at 1504 based at least in part on adaptive threshold halftoning. At 1508, edge and boundary blocks are identified in the halftoned images (e.g., by a boundary block detection component 502 at block management component 60). At 1510, candidate blocks for watermarking are selected (e.g., by a candidate block identification component 504 at block management component 60) from the edge and boundary blocks identified at 1508. At 1512, the logo is embedded in the image by performing contour shaping and modification (e.g., using a contour shaping component 70) on the candidate blocks identified at 1510.

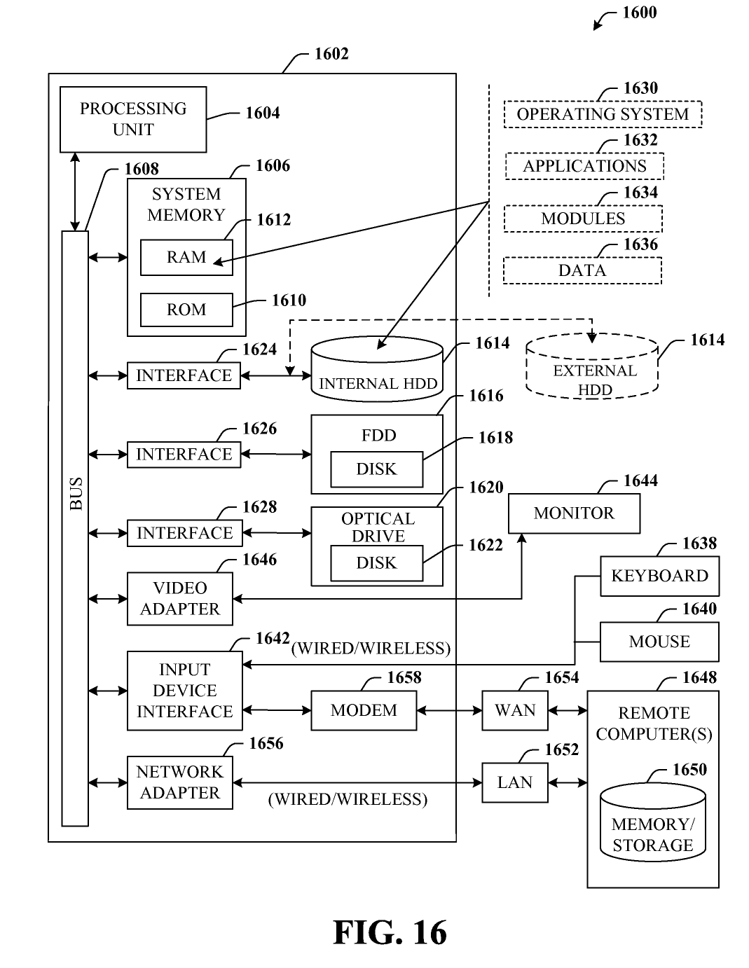

In order to provide additional context for various aspects described herein, FIG. 16 and the following discussion are intended to provide a brief, general description of a suitable computing environment 1600 in which various aspects described herein can be implemented. Additionally, while the claimed subject matter has been described above in the general context of computer-executable instructions that can run on one or more computers, those skilled in the art will recognize that the claimed subject matter also can be implemented in combination with other program modules and/or as a combination of hardware and software. Generally, program modules include routines, programs, components, data structures, etc., that perform particular tasks or implement particular abstract data types. Moreover, those skilled in the art will appreciate that the systems and methods above can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 16, the example computing environment 1600 includes a computer 1602, the computer 1602 including a processing unit 1604, a system memory 1606 and a system bus 1608. The system bus 1608 couples to system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA) that can also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE-1394 interface technologies. Other external drive connection technologies are within contemplation of the claimed subject matter.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing various methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is appreciated that the claimed subject matter can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) can include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, a serial port, an IEEE-1394 port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 can operate in a networked environment using logical connections via wired and/or wireless communications to one or more remote computers, such as remote computer(s) 1648. A remote computer 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 is connected to the local network 1652 through a wired and/or wireless communication network interface or adapter 1656. The adapter 1656 can facilitate wired or wireless communication to the LAN 1652, which can also include a wireless access point disposed thereon for communicating with the wireless adapter 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, telephone, etc. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11(a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band). Thus, networks using Wi-Fi wireless technology can provide real-world performance similar to a 10 BaseT wired Ethernet network.

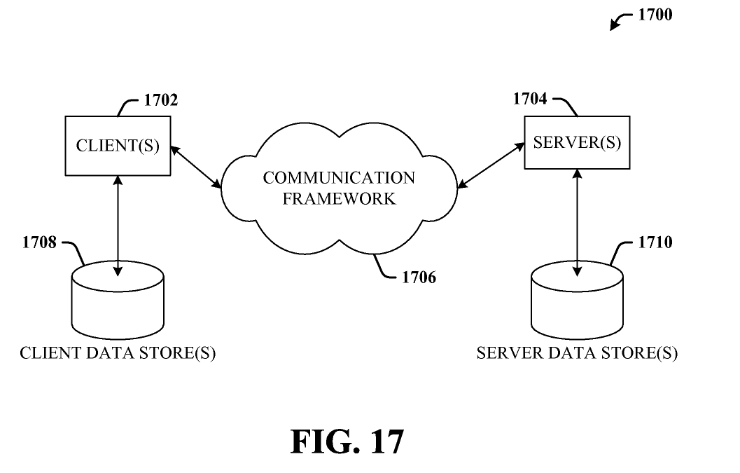

Referring now to FIG. 17, a block diagram of an example networked computing environment in which various aspects described herein can function is illustrated. The system 1700 includes one or more client(s) 1702. The client(s) 1702 can be hardware and/or software (e.g., threads, processes, computing devices). The system 1700 also includes one or more server(s) 1704. The server(s) 1704 can also be hardware and/or software (e.g., threads, processes, computing devices). One possible communication between a client 1702 and a server 1704 can be in the form of a data packet adapted to be transmitted between two or more computer processes. The data packet can include a video signal and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702. Similarly, the server(s) 1704 are operatively connected to one or more server data store(s) 1710 that can be employed to store information local to the servers 1704.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A system for watermarking a few-color image, comprising:
a halftoning component that generates a binary halftoned image based on a few-color image, the binary halftoned image distinguishes between edge pixels and content pixels in the few-color image;
a block management component that utilizes the binary halftoned image to identify one or more candidate pixel blocks for embedding watermark data in the few-color image; and
a contour shaping component that embeds a binary watermark in the few-color image to create a watermarked image by modifying contours of respective candidate pixel blocks in the few-color image.

2. The system of claim 1, further comprising a segmentation component that divides an input image into one or more few-color image segments, wherein the halftoning component, the block management component, and the contour shaping component are utilized for respective few-color image segments.

3. The system of claim 1, wherein the halftoning component generates a binary halftoned image based on a few-color image at least in part by determining a pixel value threshold, assigning a first halftone value to respective pixels in the few-color image having a pixel value equal to or greater than the pixel value threshold, and assigning a second halftone value to respective pixels in the few-color image having a pixel value less than the pixel value threshold.

4. The system of claim 1, wherein the block management component comprises:
a boundary block detection component for detecting respective pixel blocks in the binary halftoned image corresponding to boundaries between edge pixels and content pixels; and
a candidate block identification component that identifies respective pixel blocks detected by the boundary block detection component that are candidate pixel blocks for embedding watermark data.

5. The system of claim 1, wherein the contour shaping component comprises:
a contour measurement component that determines respective contours of candidate pixel blocks corresponding to a few-color image received by the block management component; and
a contour modification component that embeds a binary watermark in the few-color image by modifying respective contours of the candidate pixel blocks based at least in part on the binary watermark.

6. The system of claim 5, wherein the contour modification component modifies respective contours of the candidate pixel blocks by toggling a center pixel in the respective candidate pixel blocks between an edge color and a content color.

7. The system of claim 1, further comprising an extraction component that receives the watermarked image and extracts the binary watermark from the watermarked image.

8. The system of claim 7, wherein the watermarked image is communicated to the extraction component using a communication channel, an image compression operation is performed on the watermarked image in the communication channel, and the extraction component obtains a binary watermark from a resulting compressed image that is substantially similar to the binary watermark embedded in the watermarked image.

9. The system of claim 7, wherein the extraction component comprises:
a halftoning component that generates a binary halftoned image based on the watermarked image;
a block management component that utilizes the binary halftoned image to identify one or more candidate blocks in which the binary watermark was embedded in the watermarked image; and
a contour measurement component that obtains the binary watermark from the watermarked image at least in part by determining respective contours of edge pixels in the candidate blocks.

10. The system of claim 1, wherein a color palette of the watermarked image is substantially identical to a color palette of the few-color image.

11. A method for embedding a logo in an image, comprising:
obtaining a halftone image from the image based at least in part on adaptive threshold halftoning;
identifying candidate blocks for watermarking from the halftone image; and
embedding a logo in the image to create a watermarked image by performing contour shaping on the candidate blocks for watermarking.

12. The method of claim 11, further comprising dividing the image into one or more few-color image segments, wherein the obtaining, identifying, and embedding are respectively performed for respective few-color image segments.

13. The method of claim 11, wherein the obtaining includes:
forming a histogram based on respective pixel values in the image, the histogram comprises a peak for an edge color and one or more peaks for content colors;
determining a halftoning threshold by selecting a pixel value between the peak for the edge color and a peak for a content color;
assigning pixels in the image having a pixel value below the halftoning threshold a first halftone value; and
assigning pixels in the image having a pixel value equal to or above the halftoning threshold a second halftone value.

14. The method of claim 11, wherein the identifying includes:
dividing the halftone image into a plurality of blocks of a predetermined size;
identifying boundary blocks in the halftone image from the plurality of blocks; and
selecting candidate blocks for watermarking from the identified boundary blocks.

15. The method of claim 11, wherein the embedding includes:
determining respective contours of candidate blocks for watermarking; and
modifying respective contours of the candidate blocks for watermarking based at least in part on the logo.

16. The method of claim 15, wherein the logo comprises information bits having a first value and information bits having a second value, and the modifying includes:
setting respective contours of candidate blocks for watermarking to one of a first set of contours to represent respective information bits in the logo having the first value; and
setting respective contours of candidate blocks for watermarking to one of a second set of contours to represent respective information bits in the logo having the second value.

17. The method of claim 11, further comprising extracting the logo from the watermarked image.

18. The method of claim 17, wherein the extracting includes:
obtaining a halftone image from the watermarked image based at least in part on adaptive threshold halftoning;
identifying blocks in the watermarked image in which the logo was embedded based on the halftone image; and
extracting the logo from the watermarked image based at least in part on respective contours of the blocks in watermarked image in which the logo was embedded.

19. A computer-readable medium having stored thereon computer-executable instructions for performing the method of claim 11.

20. A system that facilitates embedding a watermark in a few-color image, comprising:
means for generating a binary halftoned image based on the few-color image;
means for identifying candidate pixel blocks for watermarking in the few-color image based at least in part on the binary halftoned image; and
means for embedding a watermark in the few-color image by modifying respective contours of the candidate pixel blocks for watermarking in the few-color image.
